(19) United States
(12) Patent Application Publication
(10) Pub. No.: US 2019/0030487 A1
(43) Pub. Date: Jan. 31, 2019

(54) FILTRATION APPARATUS

(71) Applicant: WATEROAM PTE. LTD., Singapore (SG)

(72) Inventor: Vincent -, Singapore (SG)

(21) Appl. No.: 15/775,768

(22) PCT Filed: Nov. 11, 2016
(86) PCT No.: PCT/SG2016/050562

§ 371 Date: May 11, 2018

(30) Foreign Application Priority Data
Nov. 13, 2015 (SG) 10201509365Q

(51) Int. Cl. B01D 61/18; B01D 61/20; B01D 63/02; C02F 1/44

(52) U.S. Cl. CPC B01D 61/18; B01D 61/20; B01D 63/02; C02F 2201/006; B01D 2313/18; B01D 2313/243; B01D 2321/205; C02F 1/44

(57) ABSTRACT

Various embodiments relate generally to a filtration apparatus. The filtration apparatus may include a filtration module having an inner longitudinal chamber and an outer annular chamber surrounding the inner longitudinal chamber. The filtration module may further include a base module coupled to an end of the filtration module, and an integrated check valve module coupled to a corresponding end of the inner longitudinal chamber of the filtration module through the base module. The base module and the integrated check valve module may be configured to define an annular base chamber adjacent to a corresponding end of the outer annular chamber of the filtration module. The integrated check valve module may include a housing having a first port for external fluid communication, a second port to interface with the annular base chamber and a third port to interface with the inner longitudinal chamber.

### CROSS-REFERENCE TO RELATED APPLICATIONS

The present application claims the priority of Singapore patent application no. 10201509365Q filed on 13 Nov. 2015, the entire contents of which are incorporated herein by reference for all purposes.

### TECHNICAL FIELD

Embodiments relate generally to filtration apparatus.

### BACKGROUND

Amidst the advancement in water purification technology, converting dirty water containing chemicals, biological contaminants, and/or other solid particles into clean drinking water is a problem faced by many people around the world.

Although numerous portable water filtration systems have been developed to tackle the above-stated problem, such systems are often limited in terms of deployability as well as the ease of operation and/or maintenance. In addition, most of the portable water filtration systems require electricity for operation.

There are some portable water filtration systems that do not require electricity to operate. For example, some of these systems rely on the use of hand pumps, but the pumps used in such systems are usually attached to the exterior of the container and not integrated into the system, making these systems bulky and unwieldy to operate and/or transport. In addition, such systems utilize a backwash mechanism where the filtration module can only be cleaned and maintained if the user takes certain extra steps, such as substantially changing the pump configuration to reverse the flow of water through the filtration module, or taking apart the filtration module for cleaning, or attaching additional bulky cleaning accessories.

Accordingly, example embodiments seek to provide a filtration apparatus or portable filtration apparatus that address at least some of the issues identified above.

### SUMMARY

According to various embodiments, there is provided a filtration apparatus. The filtration apparatus may include a filtration module having an inner longitudinal chamber and an outer annular chamber surrounding the inner longitudinal chamber. The filtration module may further include a base module coupled to an end of the filtration module, and an integrated check valve module coupled to a corresponding end of the inner longitudinal chamber of the filtration module through the base module. The base module and the integrated check valve module may be configured to define an annular base chamber adjacent to a corresponding end of the outer annular chamber of the filtration module. The integrated check valve module may include a housing having a first port for external fluid communication, a second port to interface with the annular base chamber and a third port to interface with the inner longitudinal chamber.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIGS. 1A and 1B show schematic diagrams of a filtration apparatus according to various embodiments;

FIGS. 2A to 2C show various views of a filtration apparatus according to various embodiments;

FIGS. 2D to 2F illustrates the operation of the filtration apparatus of FIGS. 2A to 2C according to various embodiments;

FIG. 3 shows a vertical cross-sectional view of a filtration apparatus according to various embodiments;

FIG. 4 shows a vertical cross-sectional view of a filtration apparatus according to various embodiments;

FIGS. 5A to 5C show various views of a filtration apparatus according to various embodiments;

FIG. 6 shows a perspective view of a cut-out portion of a filtration apparatus according to various embodiments;

FIGS. 7A to 7C show various views of a filtration apparatus according to various embodiments.

### DETAILED DESCRIPTION

Embodiments described below in context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

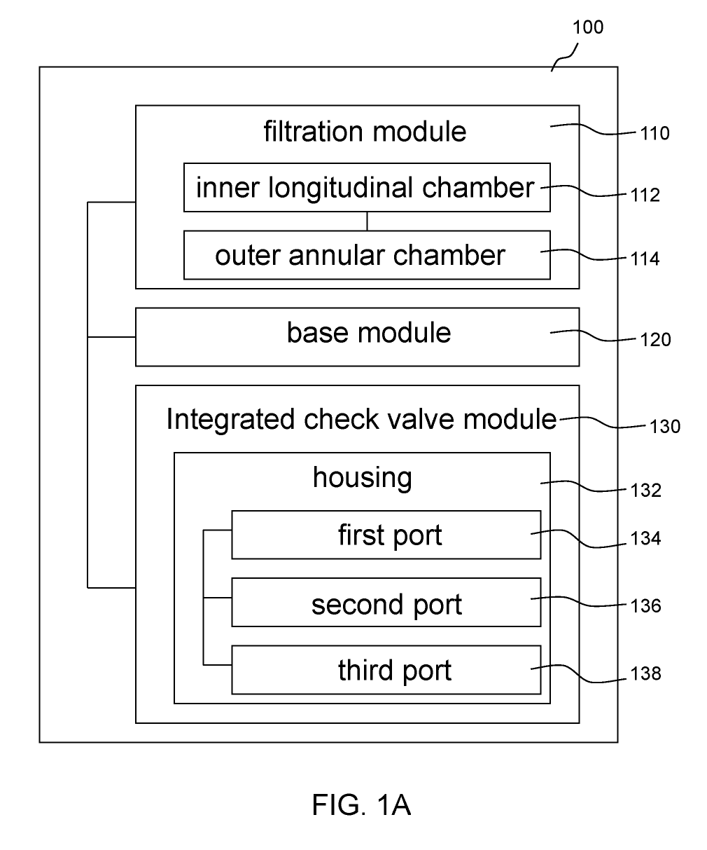

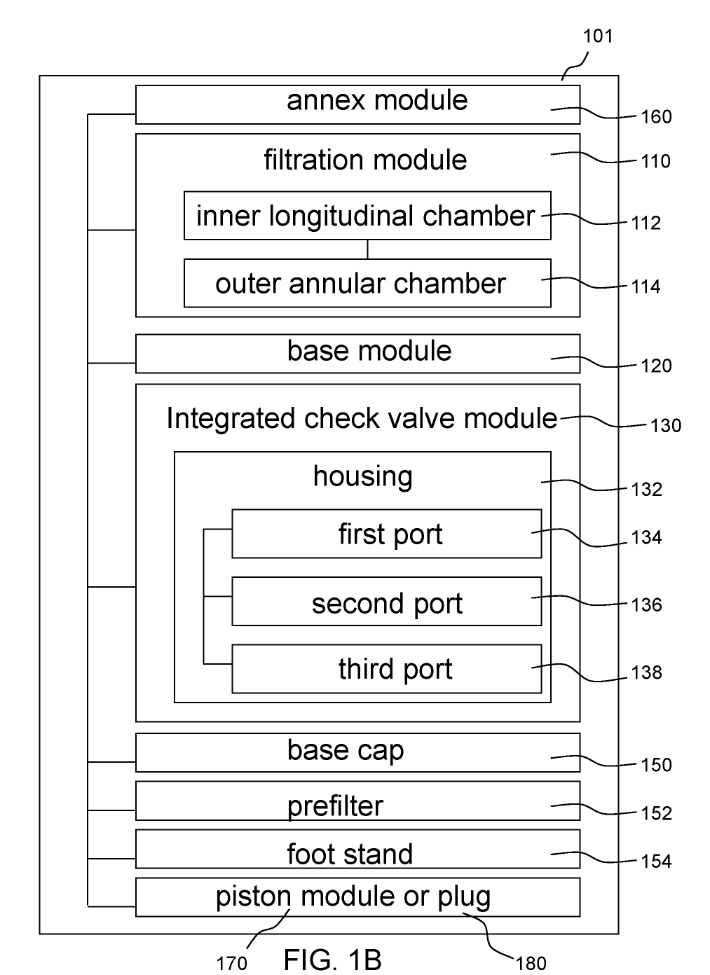

FIG. 1A shows a schematic diagram of a filtration apparatus 100 according to various embodiments. The filtration apparatus 100 may include a filtration module 110 having an inner longitudinal chamber 112 and an outer annular chamber 114 surrounding the inner longitudinal chamber 112. The filtration apparatus 100 may further include a base module 120 coupled to an end of the filtration module 110. The filtration apparatus 100 may also include an integrated check valve module 130 coupled to a corresponding end of the inner longitudinal chamber 112 of the filtration module 110 through the base module 120. The base module 120 and the integrated check valve module 130 may be configured to define an annular base chamber adjacent to a corresponding end of the outer annular chamber 114 of the filtration module 110. The integrated check valve module 130 may include a housing 132 having a first port 134 for external fluid communication, a second port 136 to interface with the annular base chamber and a third port 138 to interface with the inner longitudinal chamber 112.

In other words, the filtration apparatus 100 may include a filtration component having an inner hollow elongated body to enclose a space to form the inner longitudinal chamber 112. The inner hollow elongated body may be disposed inside an outer hollow elongated body such that a space between an exterior of the inner hollow elongated body and an interior of the outer hollow elongated body may form the outer annular chamber 114. The filtration apparatus may further include a base component attached to an end of the filtration component. The filtration apparatus may also include a valve component attached to the inner hollow elongated body of the filtration component through the base component. The base component may be shaped such that when the valve component is attached to the inner hollow elongated body through the base component, a space between an interior of the base component and an exterior of the valve component may form an annular base chamber. The valve component may be a single unitary component having a casing. The casing may include three openings. The first opening may be configured for fluid communication with water source, storage or other components external to the filtration apparatus. The second opening may be configured for direct fluid communication between the valve component and the annular base chamber. The third opening may be configured for fluid communication with the inner longitudinal chamber enclosed inside the inner hollow elongated body.

FIG. 1B shows a schematic diagram of a filtration apparatus 101 according to various embodiments. The filtration apparatus 101 may, similar to the filtration apparatus 100 of FIG. 1A, include a filtration module 110 having an inner longitudinal chamber 112 and an outer annular chamber 114 surrounding the inner longitudinal chamber 112. The filtration apparatus 101 may, similar to the filtration apparatus 100 of FIG. 1A, further include a base module 120 coupled to an end of the filtration module 110. The filtration apparatus 101 may, similar to the filtration apparatus 100 of FIG. 1A, also include an integrated check valve module 130 coupled to a corresponding end of the inner longitudinal chamber 112 of the filtration module 110 through the base module 120. The base module 120 and the integrated check valve module 130 may be configured to define an annular base chamber adjacent to a corresponding end of the outer annular chamber 114 of the filtration module 110. The integrated check valve module 130 may include a housing 132 having a first port 134 for external fluid communication, a second port 136 to interface with the annular base chamber and a third port 138 to interface with the inner longitudinal chamber 112.

According to various embodiments, the housing 132 of the integrated check valve module 130 may include an integrally formed housing.

According to various embodiments, the integrated check valve module 130 may include a first check valve coupled to the first port 134 and a second check valve coupled to the second port 136. The first check valve may be removably coupled to the first port 134. The second check valve may also be removably coupled to the second port 136.

According to various embodiments, the filtration apparatus 101 may further include a base cap 150 removably coupled to the base module 120. The base cap 150 and the base module 120 may be configured to form an auxiliary base chamber adjacent to the annular base chamber.

According to various embodiments, the base module 120 may include an opening in an external wall of the base module 120. The opening may be configured to interface with the auxiliary base chamber.

According to various embodiments, the filtration apparatus 101 may include a prefilter 152 contained in the auxiliary base chamber. The prefilter 152 may include any one of a mesh, a cloth, a paper, or a sponge.

According to various embodiments, the filtration apparatus 101 may further include a foot stand 154 attached to the base cap 150.

According to various embodiments, the outer annular chamber 114 of the filtration module 110 may include a plurality of membrane fibres. The plurality of membrane fibres may be attached at both ends to the filtration module 110.

According to various embodiments, the filtration module 110 may include an opening in an external wall of the filtration module 110.

According to various embodiments, the annular base chamber of the base module 120 may be concentric with the outer annular chamber 114 of the filtration module 110.

According to various embodiments, the filtration apparatus 101 may further include an annex module 160 coupled to another end of the filtration module 110. The annex module 160 may be configured to define an annular annex chamber adjacent to a corresponding end of the outer annular chamber 114 of the filtration module 110. The annular annex chamber of the annex module 160 may be concentric with the outer annular chamber 114 of the filtration module 110. The annex module 160 may include an opening in an external wall of the annex module 160.

According to various embodiments, the base module 120 may include a partition wall to divide the annular base chamber into two separate semi-annular base chambers. The second port 136 of the integrated check valve module 130 may be configured to interface with one of the two semi-annular base chambers. The base module 120 may include an opening in an external wall of the base module 120 to interface with another one of the two separate semi-annular base chambers.

According to various embodiments, the annex module 160 may include an air valve.

According to various embodiments, the filtration apparatus 101 may further include a piston module 170 inserted into the inner longitudinal chamber 112 of the filtration module 110. The piston module 170 may include a piston shaft, a handle at one end of the piston shaft and a piston head at another end of the piston shaft. The piston head may include a double coned rubber piston head.

According to various embodiments, the filtration apparatus 101 may further include a plug 180 coupled to another end of the inner longitudinal chamber of the filtration module.

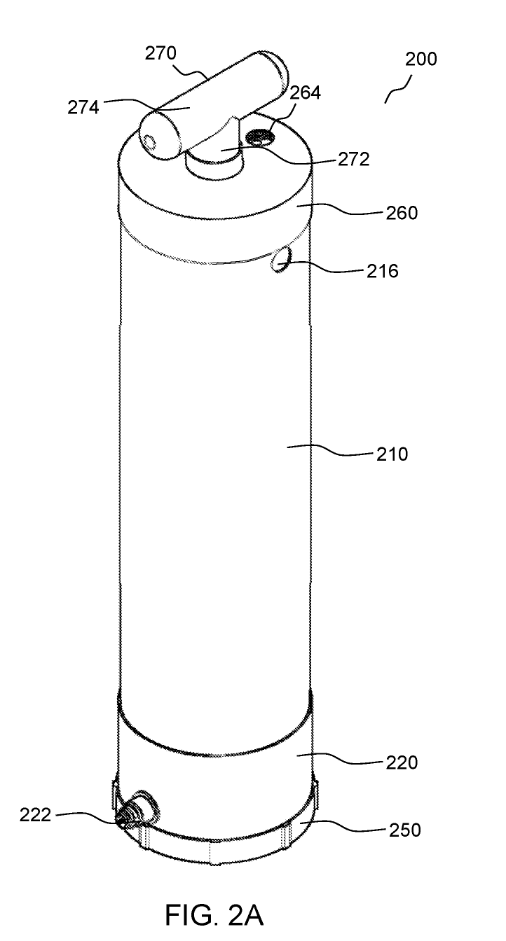

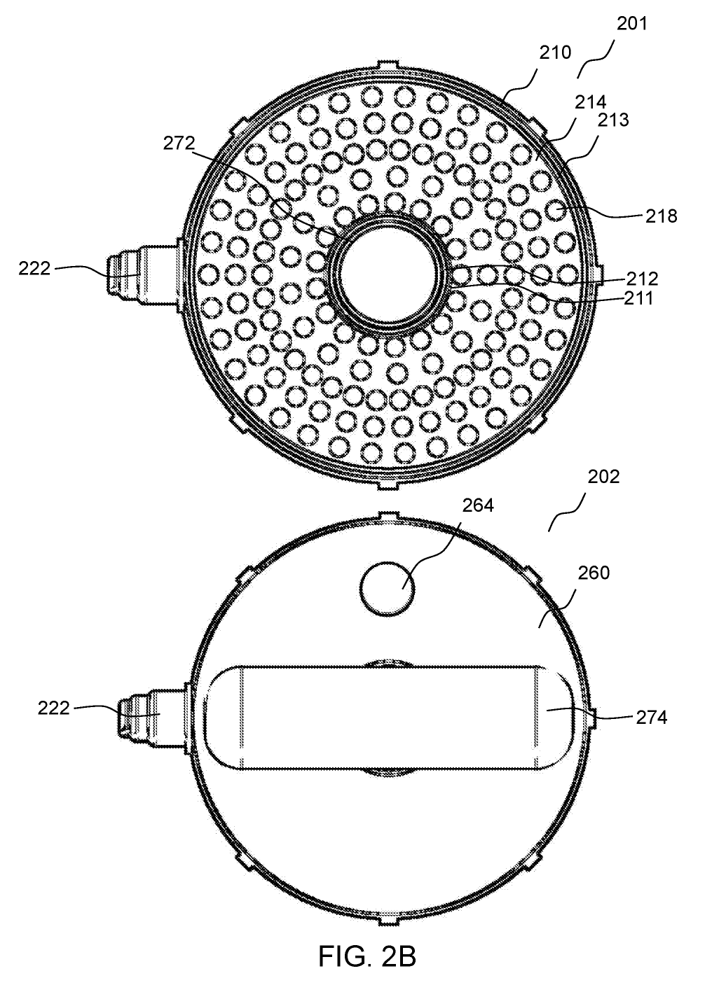

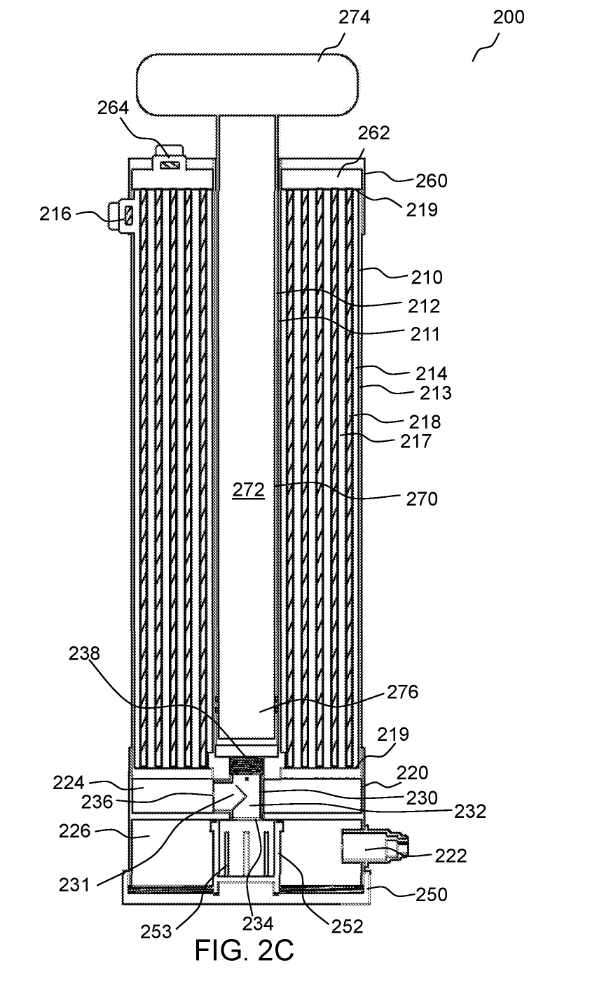

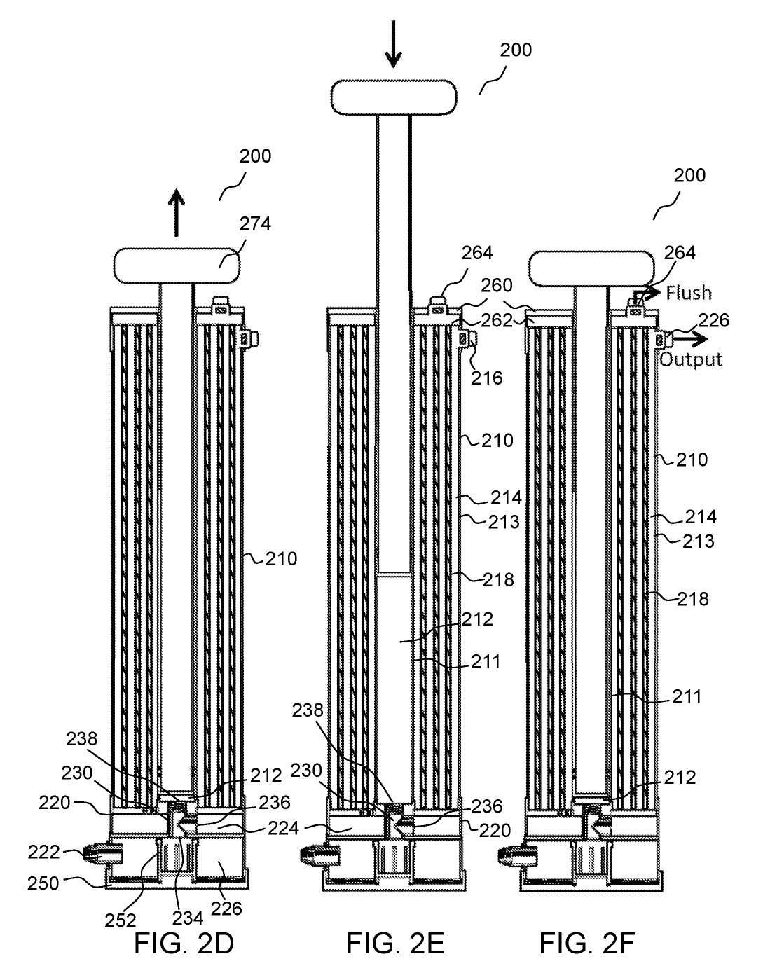

FIGS. 2A to 2C show various views of a filtration apparatus 200 according to various embodiments. FIG. 2A shows a perspective view of the filtration apparatus 200. FIG. 2B shows a horizontal cross-sectional view 201 of a mid-section of the filtration apparatus 200 and a top view 202 of the filtration apparatus 200. FIG. 2C shows a vertical cross-sectional view of the filtration apparatus 200. FIGS. 2D to 2F illustrates the operation of the filtration apparatus 200 of FIGS. 2A to 2C according to various embodiments.

As shown in FIG. 2C, the filtration apparatus 200 may include a filtration module 210 having an inner longitudinal chamber 212 and an outer annular chamber 214 surrounding the inner longitudinal chamber 212. Accordingly, the filtration module 210 may include an inner hollow elongated body 211 to enclose a space to form the inner longitudinal chamber 212. The inner hollow elongated body 211 may be disposed inside an outer hollow elongated body 213 such that a space between an exterior of the inner hollow elongated body 211 and an interior of the outer hollow elongated body 213 may form the outer annular chamber 214. Hence, the inner hollow elongated body 211 may separate the inner longitudinal chamber 212 from the outer annular chamber 214 such that a fluid contained inside the inner longitudinal chamber 212 may not flow across the inner hollow elongated body 211 to the outer annular chamber 214 and vice versa.

The filtration apparatus 200 may further include a base module 220 coupled to an end of the filtration module 210. The base module 220 may be coupled to a bottom end of the filtration module 210. The filtration apparatus 200 may also include an integrated check valve module 230 coupled to a corresponding end of the inner longitudinal chamber 212 of the filtration module 210 through the base module 220. The base module 220 and the integrated check valve module 230 may be configured to define an annular base chamber 224 adjacent to a corresponding end of the outer annular chamber 214 of the filtration module 210. Accordingly, the integrated check valve module 230 may be fitted through the base module 220 for coupling to the bottom end of the inner longitudinal chamber 212. In this manner, a space between an exterior of the integrated check valve module 230 and an interior of the base module 220 may form the annular base chamber 224.

According to various embodiments, the integrated check valve module 230 may include a housing 232 having a first port 234 for external fluid communication, a second port 236 to interface with the annular base chamber and a third port 238 to interface with the inner longitudinal chamber 212. Accordingly, the integrated check valve module 230 may be a single unit having a unitary body in the form of a housing 232 that has three ports 234, 236, 238 such that the integrated check valve module 230 may be configurable to direct flow of water through the various combinations of the ports 234, 236, 238.

According to various embodiments, the housing 232 of the integrated check valve module 230 may include an integrally formed housing.

According to various embodiments, the integrated check valve module 230 may include a first check valve coupled to the first port 234 and a second check valve coupled to the second port 236. The first check valve may be removably coupled to the first port 234. The second check valve may also be removably coupled to the second port 236. Accordingly, the first check valve and the second check valve may be arranged to direct flow of water in a predetermined direction. With the first check valve and the second check valve removable, the direction of flow of water may be changed. The check valves may also be replaced when faulty.

According to various embodiments, the filtration apparatus 200 may further include a base cap 250 removably coupled to the base module 220. The base cap 250 and the base module 220 may be configured to form an auxiliary base chamber 226 adjacent to the annular base chamber 224. With the base cap 250 being removable, the base cap 250 may be removed for accessing to the integrated check valve module 230 and a prefilter 252 for maintenance or reconfiguration.

According to various embodiments, the base module 220 may include an opening 222 in an external wall of the base module 220. The opening 222 may be configured to interface with the auxiliary base chamber 226. The opening 222 may allow dirty water to enter the auxiliary base chamber 226.

According to various embodiments, the filtration apparatus 200 may include a prefilter 252 contained in the auxiliary base chamber 226. The prefilter 252 may be disposed immediately adjacent to the first port 234 of the integrated check valve 230 such that water flowing to the first port 234 may be filtered to remove sediments or rocks which may clog the integrated check valve 230. The prefilter 252 may include any one of a mesh, a cloth, a paper, or sponge.

According to various embodiments, the filtration apparatus 200 may further include a foot stand (not shown) attached to the base cap 250. The foot stand may allow the filtration apparatus 200 to be placed stably in an upright orientation.

According to various embodiments, the outer annular chamber 214 of the filtration module 210 may include a plurality of membrane fibres 218. The plurality of membrane fibres 218 may be attached at both ends 219 to the filtration module 110. The attachment of the plurality of membrane fibres 218 may be via potting technique whereby the plurality of membrane fibres 218 are potted through a layer of sealant.

According to various embodiments, the filtration module 210 may include an opening 216 in an external wall of the filtration module 110. The opening 216 may allow filtered water to exit the filtration module 110.

According to various embodiments, the annular base chamber 224 of the base module 220 may be concentric with the outer annular chamber 214 of the filtration module 210.

According to various embodiments, the filtration apparatus 200 may further include an annex module 260 coupled to another end of the filtration module 210. The annex module 260 may be configured to define an annular annex chamber 262 adjacent to a corresponding end of the outer annular chamber 214 of the filtration module 210. The annular annex chamber 262 of the annex module 260 may be concentric with the outer annular chamber 214 of the filtration module 210. The annex module 260 may further include an opening 264 in an external wall of the annex module 260. The opening 264 may be an air valve as well as an outlet for dirty water to exit during flushing and cleaning of the plurality of membrane fibres 218.

According to various embodiments, the filtration apparatus 200 may further include a piston module 270 inserted into the inner longitudinal chamber 212 of the filtration module 210. The piston module 270 may include a piston shaft 272, a handle 274 at one end of the piston shaft and a piston head 276 at another end of the piston shaft 272.

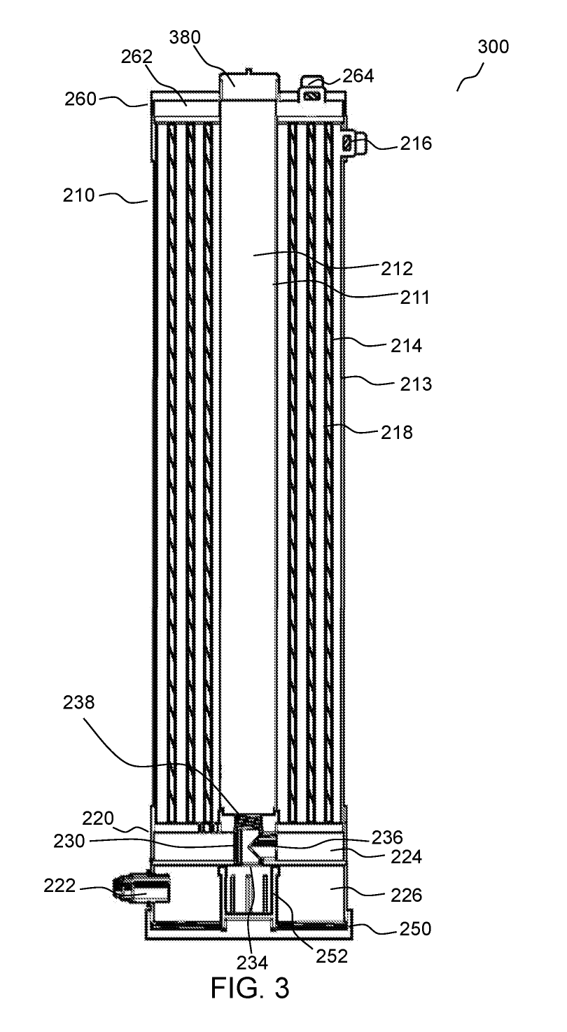

FIG. 3 shows a vertical cross-sectional view of a filtration apparatus 300 according to various embodiments. The filtration apparatus 300 of FIG. 3 differs from the filtration apparatus 200 of FIGS. 2A to 2D in that the filtration apparatus 300 may include a plug 380, coupled to another end of the inner longitudinal chamber 212 of the filtration module 210, instead of the piston module 270. In this embodiment, the piston module 270 may be removed to facilitate operation of the filtration apparatus 300 via the use of gravitational tank feed, electric pump, etc. Accordingly, the water source may be connected directly to the opening 222 in the base module 220.

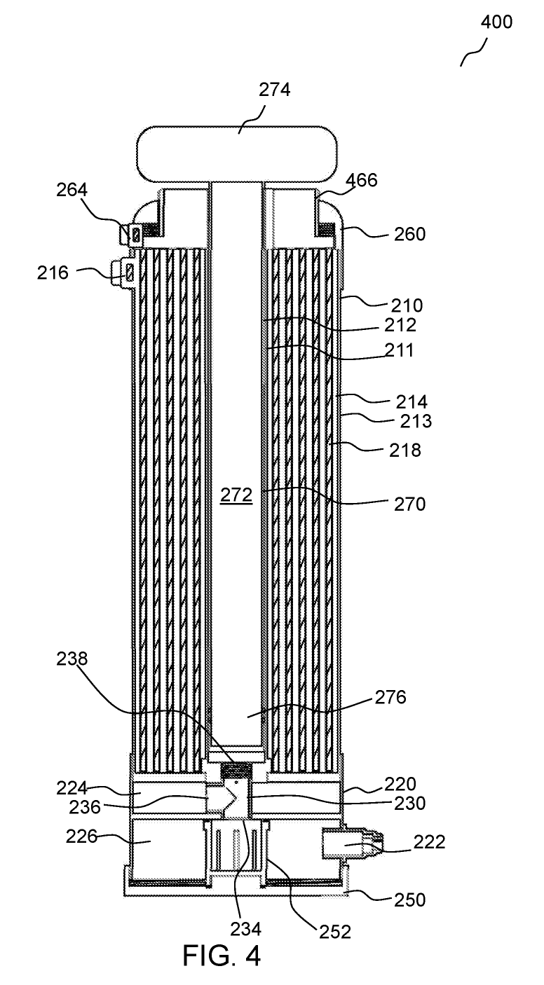

FIG. 4 shows a vertical cross-sectional view of a filtration apparatus 400 according to various embodiments. The filtration apparatus 400 in FIG. 4 differs from the filtration apparatus 200 of FIGS. 2A to 2D in that the annex module 260 of the filtration apparatus 400 may include a removable lid 466. The removable lid 466 may replace the opening 264 in the annex module 260. The removable lid 466 may be removed such that dirty water may flow out of the annex module 260 during flushing and cleaning of the plurality of membrane fibres 218.

In the embodiments depicted in FIGS. 2A to 2F, 3 and 4, the filtration apparatus 200, 300, 400 may contain the opening 222, shown as an inlet or hose connector, where dirty water containing contaminants such as microorganisms, colloids, suspended solids and/or physical particles may be allowed to enter the filtration module 210, and an opening 216, serving as an outlet, where clean water may be allowed to exit the filtration module 210.

In the embodiment depicted in FIG. 2C, the bottom of the filtration apparatus 200 may include the base module 220, shown as a customised pipe joint that is fitted to the filtration module 210, and the base cap 250 shown as a screw cap. The base cap 250 may be detached to expose the prefilter 252. The prefilter 252 may include one or more slits 253 where materials such as a mesh, a cloth, a paper, or a sponge may optionally be mounted, to remove suspended impurities from the dirty water. The prefilter 252 may be detachable from the base module 220 and may be replaced once it is dirty. When the prefilter 252 is attached to the base module 220, the base cap 250 may be screwed in, securing the prefilter 252 in place.

The filtration module 212 may include the inner hollow elongated body 211 defining the inner longitudinal chamber 212, which may include a hollow stem, within which the piston module 270, shown as an integrated hand-operated piston pump, may be moved up and down. The filtration module 210 may be attached to the annex module 260, which may include an end cap, at the top end of the filtration module 210, and the base module 220 at the bottom end of the filtration module 210. The piston module 270 in the form of the hand-operated piston pump may be integrated into the inner longitudinal chamber 212 for ease of operation and transport, but may be removed when not required (for example, in areas where there is a source of dirty water with high water head, the hand-operated piston pump need not be used to obtain clean water, and can be optionally removed with inner longitudinal chamber 212 being sealed with a plug 380, shown as a top end cap in FIG. 3).

The filtration module 210 may also contain the plurality of membrane fibres 218, which may include tubular/capillary/multi-bore membrane fibres, for filtering dirty water. There may be an opening 264, which may include a flush valve, located at the top of the annex module 260 of the filtration module 210, and the flush valve may be “opened” or “closed”. In other embodiments (see FIG. 4), instead of the flush valve, a removable lid 466 may optionally be mounted onto the top of the filtration module 212 by means of grooved threads which are located on the hollow stem or on the walls of the inner longitudinal chamber 212, or by some other means (including but not limited to magnets, clamps, or hinges).

The integrated check valve module 230, which may include a tee joint 231 with two check valves, may be fitted to the bottom of the inner longitudinal chamber 212 and fitted to the base module 220. The check valve located at the bottom 234 of the tee joint 231 may allow uni-directional flow of dirty water up into the inner longitudinal chamber 212. The check valve located at the middle 236 of the tee joint 231 may allow uni-directional flow of dirty water out of the inner longitudinal chamber 212, and up into the plurality of membrane fibres 218.

When the piston module 270 in the form of the hand-operated piston pump is pulled up (see FIG. 2D), dirty water may be drawn up the inner longitudinal chamber 212 of the filtration module 210. Subsequently, when the hand-operated piston pump is pushed down (see FIG. 2E), the pressure exerted may cause the dirty water to be pushed down the inner longitudinal chamber 212 and up into the plurality of membrane fibres 218, via the integrated check valve module 230 including the tee joint 231 with the two check valves. Each check valve in the tee joint 231 may be opened and closed alternately to each other by the up and down motion of the piston module 270 in the form of the hand-operated piston pump. More specifically, when the hand-operated piston pump is pulled up, the check valve located at the middle 236 of the tee joint 231 may close and the check valve located at the bottom 234 of the tee joint 231 may open simultaneously. This may allow the dirty water to enter the inner longitudinal chamber 212 and prevent the water in the filtration module 210 from re-entering to the inner longitudinal chamber 212. When the piston pump is pushed downwards, the check valve located at the middle 236 of the tee joint 231 may open and the check valve located at the bottom 234 of the tee joint 231 may close simultaneously, allowing the dirty water in the inner longitudinal chamber 212 to enter the filtration module 212 and prevent it from returning back to the bottom of the base module 220.

When the flush valve at the opening 264 of the annex module 260 is in the “closed” position (see FIG. 2F), or when the optional removable lid 466 (see FIG. 4) is mounted onto the top of the filtration module 212, an inside-out filtration process may be used to clean the dirty water. Through the repetitive pumping action of the human user operating the piston module 270 in the form of the hand-operated piston pump (see FIGS. 2D to 2F), the dirty water entering opening 222, such as the inlet or hose connector, of the filtration apparatus 200 may be drawn up the plurality of membrane fibres 218 of the filtration module 212, and clean water may be forced out sideways across the plurality of membrane fibres 218. The clean water may accumulate inside a clean water chamber 217 of the filtration module 212, and leave the filtration module 212 via the opening 216, shown as an outlet, in the exterior wall of the filtration module 210. The clean water chamber 217 may be a space between an exterior of the membrane fibre 218 and an interior of the outer hollow elongated body 213 within the outer annular chamber 214 of the filtration module 210. On the other hand, the contaminants such as microorganisms, colloids, suspended solids and/or physical particles that are smaller than the pore size of the plurality of membrane fibres 218 may be left or trapped within the lumen of the plurality of membrane fibres 218.

When the flush valve at the opening 264 of the annex module 260 is in the “opened” position (see FIG. 2F), or when the optional removable lid 466 (see FIG. 4) is removed from the top of the filtration module 210, a flushing mechanism may be used to clean the lumen of the plurality of membrane fibres 218 and clear them of the accumulated microorganisms, colloids, suspended solids, and/or physical particles. The same repetitive pumping action of the human user operating the piston module 270 in the form of the integrated hand-operated piston pump (see FIGS. 2D to 2F) may cause the water entering the opening 222, such as the inlet or hose connector, to be drawn up into the lumen of the plurality of membrane fibres 218 of the filtration module 210, and out through the top of the plurality of membrane fibres 218, together with the accumulated microorganisms, colloids, suspended solids, and/or physical particles. In the embodiment shown in FIGS. 2A to 2C, the dirty water may then leave the filtration module 210 via the flush valve at the opening 264 of the annex module 260.

In areas where there is water source with sufficient water head provided, the use of the piston module 270 in the form of the hand-operated piston pump may not be necessary to produce filtered water. As depicted in FIG. 3, dirty water may enter the filtration module 210 via the opening 222 of the base module 220, and the ensuing clean filtered water may eventually exit via the opening 216, in the form of the outlet. As dirty water enters the opening 222 of the base module 220, air inside the filtration apparatus 300 may be purged by maintaining the opening 216 in an opened state. Once the dirty water is observed at the opening 216, the opening 216 may be shut such that pressure may built up within the filtration apparatus 300 for filtration to occur at the plurality of membrane fibres 218. The flushing mechanism may be the same as previously described.

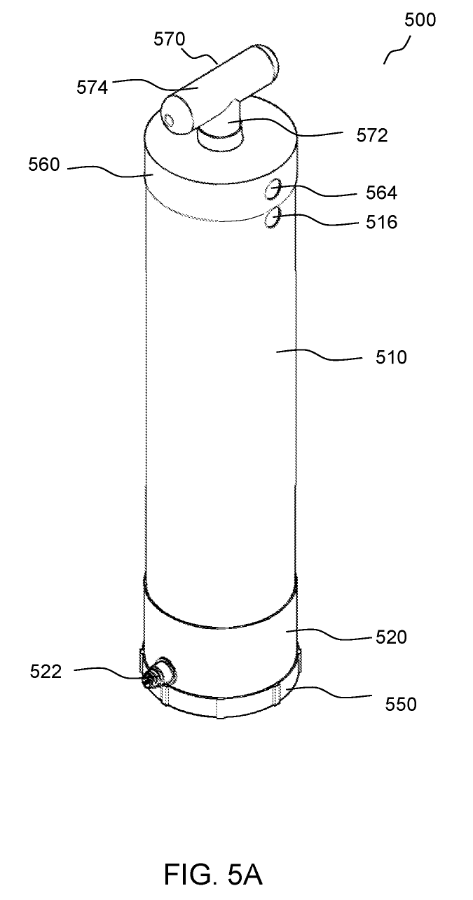

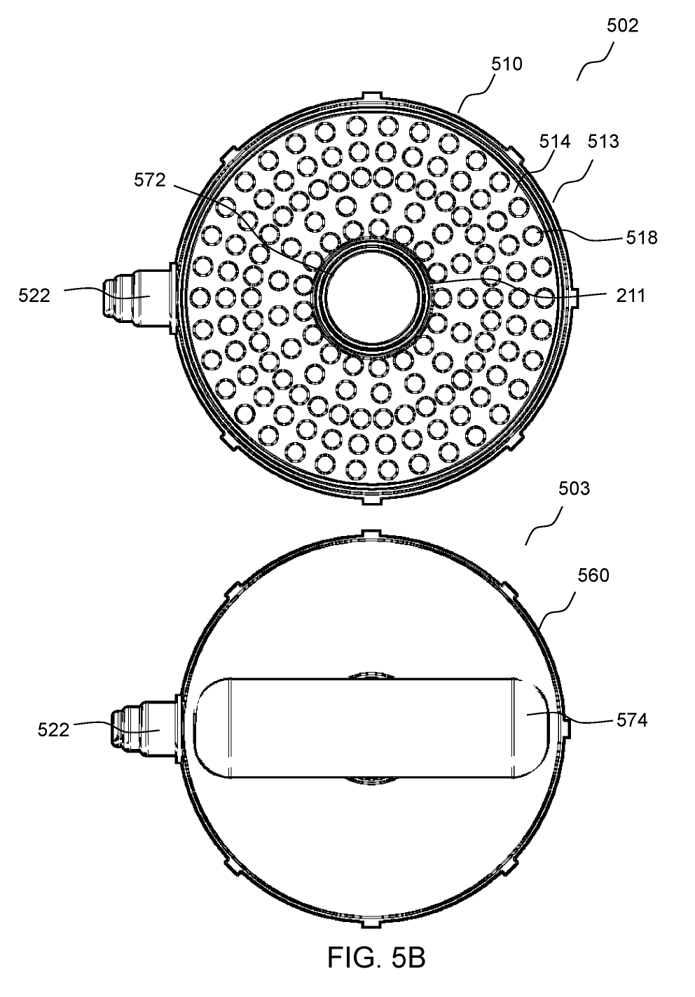

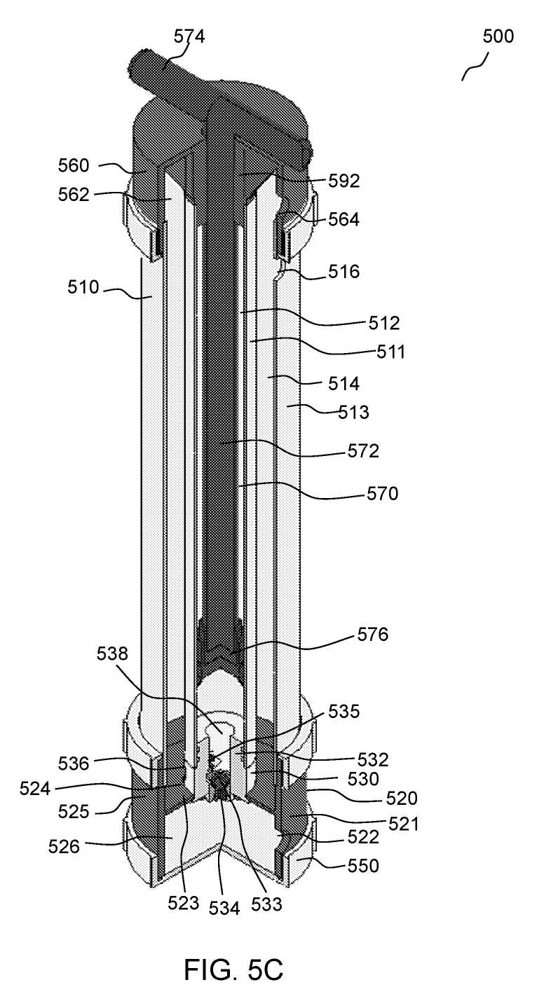

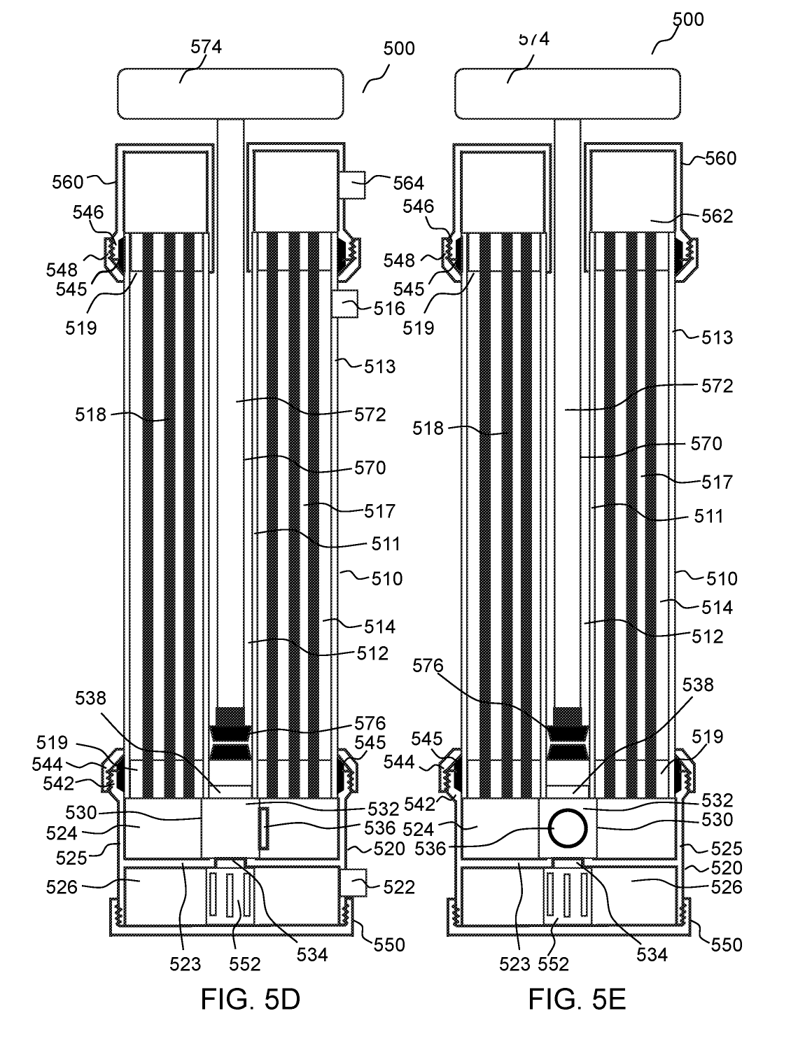

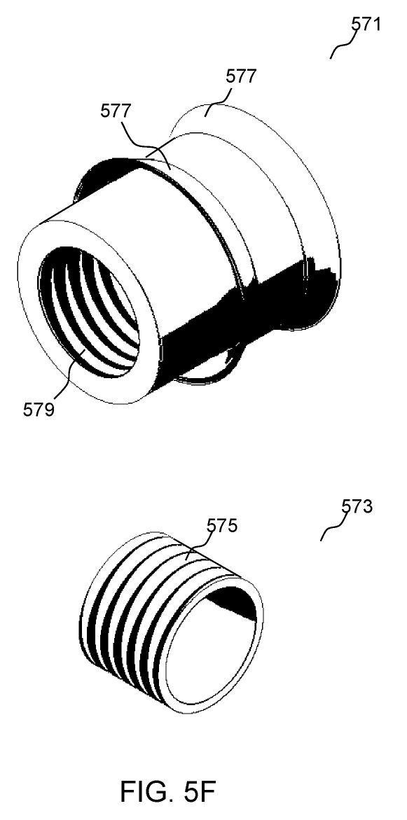

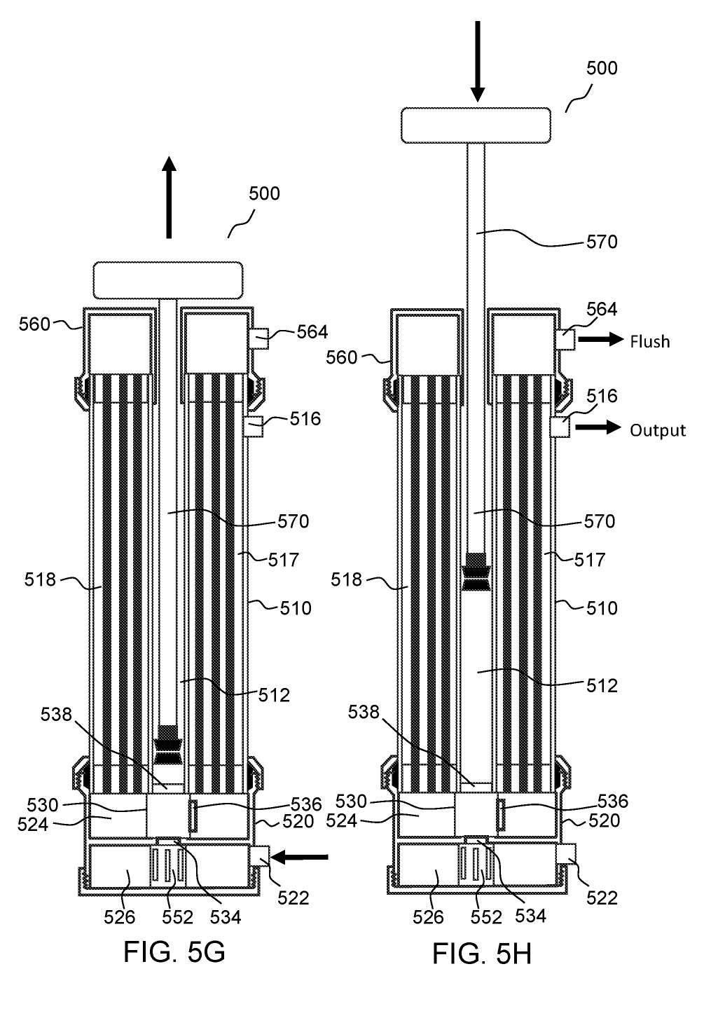

FIGS. 5A to 5H show various views of a filtration apparatus 500 according to various embodiments. FIG. 5A shows a perspective view of the filtration apparatus 500 according to various embodiments. FIG. 5B shows a horizontal cross-sectional view 502 of a mid-section of the filtration apparatus 500 and a top view 503 of the filtration apparatus 500 according to various embodiments. FIG. 5C shows a perspective view of a cut out portion of the filtration apparatus 500 according to various embodiments. FIG. 5D shows a side vertical cross-sectional view of the filtration apparatus 500 according to various embodiments. FIG. 5E shows a front vertical cross-sectional view of the filtration apparatus 500 according to various embodiments. FIG. 5F shows a piston head of the filtration apparatus 500 according to various embodiments. FIGS. 5G and 5H show the operation of the filtration apparatus 500 according to various embodiments. FIG. 5I shows a perspective view of a cut out portion of a filtration apparatus 501 according to various embodiments.

As shown in FIGS. 5A to 5E, the filtration apparatus 500 may include a filtration module or a membrane module 510 having an inner longitudinal chamber 512 and an outer annular chamber 514 surrounding the inner longitudinal chamber 512. Accordingly, the filtration module 510 may include an inner hollow elongated body 511 to enclose a space to form the inner longitudinal chamber 512. The inner hollow elongated body 511 may be disposed inside an outer hollow elongated body 513 such that a space between an exterior of the inner hollow elongated body 511 and an interior of the outer hollow elongated body 513 may form the outer annular chamber 514. According to various embodiments, the filtration module 510 may include two cylinders, an inner hollow cylinder and an outer hollow cylinder. The inner hollow cylinder may be disposed inside the outer hollow cylinder.

The filtration apparatus 500 may further include a base module 520 coupled to an end of the filtration module 510. The base module 520 may be secured to the filtration module 510 through any suitable fastener or a combination of fasteners such as adhesive, snap-fit components, thermal bonding, welding, screw fittings, compression fittings or the like. For example, as shown in FIGS. 5D and 5E, the base module 520 may include an external screw thread portion 542 at an end of the base module 520. The filtration module 510 may include a corresponding collar portion 544 encircling a rim of an end of the filtration module 510 (see FIGS. 5D and 5E). The collar portion 544 may form a groove around the rim of the filtration module 510 for receiving the end of the base module 520. The collar portion 544 may include an internal screw thread for cooperating with the external screw thread portion 542 of the base module 520. According to various embodiments, a rubber sleeve 545 may be included in the groove formed by the collar portion 544 such that coupling of the external screw thread portion 542 of the base module 520 and the collar portion 544 of the filtration module 510 may form a water-tight coupling.

The filtration apparatus 500 may also include an integrated check valve module 530 coupled to a corresponding end of the inner longitudinal chamber 512 of the filtration module 510 through the base module 520. The base module 520 and the integrated check valve module 530 may be configured to define an annular base chamber 524 adjacent to a corresponding end of the outer annular chamber 514 of the filtration module 510.

The integrated check valve module 530 may include a housing 532 having a first port 534 for external fluid communication, a second port 536 to interface with the annular base chamber 524 and a third port 538 to interface with the inner longitudinal chamber 512. According to various embodiments, the housing 532 of the integrated check valve module 530 may be in the form of a hollow body such as a hollow cylinder. The first port 534 may be an opening at one end of the hollow body and the third port 538 may be another opening at another end of the hollow body. The second port 536 may be an opening through a wall of the hollow body. When the housing 532 is a hollow cylinder, the second port 536 may be an opening through a cylindrical surface of a wall of a hollow cylinder.

According to various embodiments, the base module 520 may include a hollow body 521 with an annular plate 523 at a mid-section of the hollow body 521. When the base module 520 is coupled to the filtration module 510 with the integrated check valve module 530 coupled to the inner longitudinal chamber 512 through the annular plate of the base module 520, the annular base chamber 524 may be defined by a wall 525 of the hollow body 521 of the base module 520, the annular plate 523 of the base module 520 and an exterior of the integrated check valve module 530. Accordingly, with the second port 536 of the integrated check valve module 530 interfacing with the annular base chamber 524, water may flow from the integrated check valve module 530 into the annular base chamber 524.

According to various embodiments, the housing 532 of the integrated check valve module 530 may include an integrally formed housing. According to various embodiments, the housing 532 of the integrated check valve module 530 may be shaped or dimensioned to be tightly-fitted with the inner longitudinal chamber 512 as well as to be tightly-fitted with the annular plate 523 of the base module 520. According to various embodiments, the connection between the integrated check valve module 530 and the inner longitudinal chamber 512 may be watertight. Similarly, the connection between the integrated check valve module 530 and the annular plate 523 of the base module 520 may be watertight. The integrated check valve module 530 may further include a first check valve 533 coupled to the first port 534 and a second check valve 535 coupled to the second port 536. The first check valve 533 may be removably coupled to the first port 534 of the integrated check valve module 530. Accordingly, the first check valve 533 may be detachable to allow the first check valve 533 to be re-inserted in the reversed direction for allowing the reversal of the direction of flow. The second check valve 535 may also be removably coupled to the second port 536 of the integrated check valve module 530.

According to various embodiments, the filtration apparatus 500 may further include a base cap 550 removably coupled to the base module 520. The base cap 550 may include a bottom cap screw. The base cap 550 may be secured to the base module 520 through screwing method. The base cap 550 and the base module 520 may be configured to form an auxiliary base chamber 526 adjacent to the annular base chamber 524. Accordingly, the auxiliary base chamber 526 may be defined by the wall 525 of the hollow body 521 of the base module 520, the annular plate 523 of the base module 520 and the base cap 550.

According to various embodiments, the base module 520 may include an opening 522 in an external wall of the base module 520. The opening 522 may be configured to interface with the auxiliary base chamber 526. Accordingly, the opening 522 may be configured to be connected to a dirty water source. The opening 522 may also include threading for connections. According to various embodiments, the opening 522 may include a hose connector as shown in FIG. 5A.

According to various embodiments, the filtration apparatus 500 may include a prefilter 552 (see FIGS. 5D and 5E) contained in the auxiliary base chamber 526. The prefilter 552 may include any one of a mesh, a cloth, a paper, or a sponge. The prefilter 552 may be accessed and replaced by removing the base cap 550 when necessary.

According to various embodiments, the filtration apparatus 500 may further include a foot stand (not shown) attached to the base cap 550 of the base module 520.

According to various embodiments, the outer annular chamber 514 of the filtration module 510 may include a plurality of membrane fibres 518 (see FIGS. 5B, 5D and 5E). The plurality of membrane fibres 518 may be attached at both ends to the filtration module 510. The plurality of membrane fibres 518 may be mounted inside the outer annular chamber 514 through membrane potting technique. Accordingly, the plurality of membrane fibres 518 may be potted through a seal 519 at both ends of the outer annular chamber 514. In this manner, a sealed volume or a clean water compartment 517 may be formed between the exterior of the plurality of membrane fibres 518, the interior of the outer hollow elongated body 513 and the seal 519. Water may flow through the lumen of the plurality of membrane fibres 518 from one end of the plurality of membrane fibres 518 to the other end of the plurality of membrane fibres 518. Further, under pressurized condition, the water may then be filtered across the plurality of membrane fibres 518 such that clean water is obtained inside the sealed volume 517.

According to various embodiments, the filtration module 510 may include an opening 516 in an external wall of the filtration module 510. The opening 516 may serve as an outlet where clean water may flow out of the filtration module 510. As described above, the sealed volume or the clean water compartment 517 may be perfectly sealed from other chambers or compartments. Thus, cross contamination may be avoided.

According to various embodiments, the annular base chamber 524 of the base module 520 may be concentric with the outer annular chamber 514 of the filtration module 510.

According to various embodiments, the filtration apparatus 500 may further include an annex module 560 coupled to another end of the filtration module 510. According to various embodiments, the annex module 560 may include a top cap. The annex module 560 may be coupled to the filtration module 510 via any suitable fastener or a combination of fasteners, such as adhesive, snap-fit components, thermal bonding, welding, screw fittings, compression fittings or the like, to secure the annex module 560 to the filtration module 510. For example, as shown in FIGS. 5D and 5E, the fastener may include screw thread with which screwing action may compress and secure the annex module 560. According to various embodiments, the annex module 560 may include an external screw thread portion 546 at an end of the annex module 560. The filtration module 510 may include another collar portion 548 encircling the rim of another end of the filtration module 510. The collar portion 548 may form a groove around the rim of the filtration module 510 for receiving the end of the annex module 560. The collar portion 548 may further include an internal screw thread for cooperating with the external screw thread portion 546 of the annex module 560. According to various embodiments, a rubber sleeve 545 may be included in the groove formed by the collar portion 548 such that coupling of the external screw thread portion 546 of the annex module 560 and the collar portion 548 of the filtration module 510 may form a water-tight coupling.

According to various embodiments, the annex module 560 may be configured to define an annular annex chamber 562 adjacent to a corresponding end of the outer annular chamber 514 of the filtration module 510. The annular annex chamber 562 of the annex module 560 may be concentric with the outer annular chamber 514 of the filtration module 510. The annex module 560 may include an opening 564 in an external wall of the annex module 560. The opening 564 may include a flush point from which dirty water may exit from the filtration apparatus 500. Accordingly, dirty water may be flushed from the opening 564 after passing through the plurality of membrane fibres 518 in the filtration module 510.

According to various embodiments, the filtration apparatus 500 may further include a piston module 570 inserted into the inner longitudinal chamber 512 of the filtration module 510. The piston module 570 may include a piston shaft 572, a handle 574 at one end of the piston shaft and a piston head 576 at another end of the piston shaft.

According to various embodiments, the piston shaft 572 and the handle 574 may be made of hollow pipes.

According to various embodiments, the piston head 576 may include a double coned rubber piston head (see FIGS. 5D and 5E). FIG. 5F shows a double coned rubber piston head 571 and a connector 573 for connecting the double coned rubber piston to the piston shaft 572 according to various embodiments. As shown, the connector 573 may be cylindrical in shape and may be threaded 575 on an exterior surface. The connector 573 may be mounted permanently, for example via interference fit or other suitable attachment means, on an end of the piston shaft 572. As shown, the double coned rubber piston 571 may include at least two opposing frusto-conical shape 577. The two opposing frusto-contical shape 577, when the double coned rubber piston 571 is coupled to the end of the piston shaft 572, may maintain a watertight seal with the inner hollow elongated body 511. According to various embodiments, the double coned rubber piston 571 may include an internal screw thread 579 for mating with the external thread 575 of the connector 573. Accordingly, the double coned rubber piston 571 may be screwed to the connector 573 for coupling to the end of the piston shaft 572. This may allow replacement should the rubber become exhausted.

FIG. 5I show a filtration apparatus 501 according to various embodiments. The filtration apparatus 501 of FIG. 5I differs from the filtration apparatus 500 of FIG. 5A in that the filtration apparatus 501 further include a connector 590. The connector 590 may be configured to connect the annex module 560 to the filtration module 510 and to allow the insertion of the piston module 570 into the inner longitudinal chamber 512. The connector 590 may be configured to prevent leakage during the piston movement of the piston module 570. For example, the connector 590 may incorporate the tight fit concept of o-rings. According to various embodiments, the connector 590 may be configured and sized to allow the piston shaft 572 to move up and down freely without obstruction.

Referring to FIG. 5C, the filtration apparatus 500 may include a connecting portion 592 in place of the connector 590 of the filtration apparatus 501 of FIG. 5I. The connecting portion 592 may be integrally formed with the annex module 560. The connecting portion 592 may be configured to prevent leakage during piston movement of the piston module 570. The connecting portion 592 may also be configured and sized to allow the piston shaft 572 to move up and down freely without obstruction.

FIGS. 5G and 5H illustrates the operation of the filtration apparatus 500 according to various embodiments. According to various embodiments, the filtration apparatus 501 of FIG. 5I may also be operated in similar manner.

In use, clean water may be produced by the filtration apparatus 500, 501. To produce clean water with the filtration apparatus 500, the piston module 570 may be pulled upwards to create a suction pressure for dirty water to enter the filtration apparatus 500, 501 through opening 522 in the base module 520. The dirty water may pass through the prefilter 552 in the auxiliary base chamber 526, leaving behind larger sized particles and sediments that may damage the check valves and block the membrane. The water may then flow through the first check valve 533 at the first port 534 of the integrated check valve module 530, and through the third port 538 of the integrated check valve module 530 into the inner longitudinal chamber 512 of the filtration module 510. At this point, the second check valve 535 at the second port 536 of the integrated check valve module 530 may be closed. Subsequently, a downward push of the piston module 570 may push the water from the inner longitudinal chamber 512 through the third port 538 of the integrated check valve module 530, and through the second check valve 535 at the second port 536 of the integrated check valve module 530 into the annular base chamber 524. At this point, the first check valve 533 at the first port 534 of the integrated check valve module 530 may be closed, thus preventing the water from flowing back to the auxiliary base chamber 526. From the annular base chamber 524, the water may travel into the inner lumen of the plurality of membrane fibres 518 in the filtration module 510. According to various embodiments, the opening 564 in the annex module 560 may be opened initially to release the air within the filtration apparatus 500, 501 for filing up with water. Accordingly, water may fill up the auxiliary base chamber 526, the inner longitudinal chamber 512, the annular base chamber 524, the plurality of membrane fibres 518 and the annular annex chamber 562. After the filtration apparatus 500, 501 is filled with water, the opening 564 in the annex module 560 may be closed. Subsequently, continuous pumping of the piston module 570 may increase the pressure of the water within the lumen of the plurality of membrane fibres 518 such that water may be filtered across the plurality of membranes fibres 518. Accordingly clean water may be produced and collected in the sealed volume 517. Clean water may then exit from the filtration apparatus 500 through the opening 516 in the wall of the filtration module 510.

In use, the lumen of the plurality of membrane filters 518 may be cleaned. To clean the lumen of the plurality of membrane filters 518, the piston module 570 may be pulled upwards to create a suction pressure for water to enter the filtration apparatus 500 through opening 522 in the base module 520. The water may pass through the prefilter 552 in the auxiliary base chamber 526. Water may then flow through the first check valve 533 at the first port 534 of the integrated check valve module 530, and through the third port 538 of the integrated check valve module 530 into the inner longitudinal chamber 512 of the filtration module 510. At this point, the second check valve 535 at the second port 536 of the integrated check valve module 530 may be closed. Subsequently, a downward push of the piston module 570 may push the water from the inner longitudinal chamber 512 through the third port 538 of the integrated check valve module 530, and through the second check valve 535 at the second port 536 of the integrated check valve module 530 into the annular base chamber 524. At this point, the first check valve 533 at the first port 534 of the integrated check valve module 530 may be closed, thus preventing water from flowing back to the auxiliary base chamber 526. Continuous pumping action may cause the water to travel from the annular base chamber 524 through the inner lumen of the plurality of membrane fibres 518 and into the annex module 560. When the opening 564 in the annex module 560 is opened, the water may fill up the annular annex chamber 562 and flow out of the filtration apparatus 500 through the opening 564 in the annex module 560. Continuous pumping of the piston module 570 may flush the water through the lumen of the plurality of membrane fibres 518 such that particles, colloids, microorganisms and suspended solids that are within the lumen of the membrane may be flushed through the plurality of membranes fibres 518 and out from the opening 564 in the annex module 560. Accordingly, dirty water may then exit from the filtration apparatus 500 through the opening 564 in the annex module 560 and the plurality of membrane filters may be cleaned.

In use, the lumen of the plurality of membrane filters 518 and the prefilters 552 may be cleaned via generating a backwash. To generate the backwash for cleaning, the integrated check valve module 530 may be removed from the filtration apparatus 500 by removing the base cap 550 followed by the integrated check valve module 530. With the integrated check valve module 530 removed, the second check valve 535 at the second port 536 may be removed and fitted to the opening 564 of the annex module 560. Subsequently the integrated check valve module 530 and the base cap 550 may be fitted back to the filtration apparatus 500. With the second check valve 535 removed from the integrated check valve module 530 and fitted to the opening 564 of the annex module 560, backwash may be generated to clean the lumen of the plurality of membrane filters 518.

To generate the backwash, the piston module 570 may be pulled upwards to create a suction pressure for water to enter the filtration apparatus 500, 501 through opening 522 in the base module 520. The water may then flow through the first check valve 533 at the first port 534 of the integrated check valve module 530, and through the third port 538 of the integrated check valve module 530 into the inner longitudinal chamber 512 of the filtration module 510. At this point, the second check valve 535 fitted at the opening 564 of the annex module 560 may be closed as the first check valve 533 opens for water to flow into the inner longitudinal chamber 512. Subsequently, a downward push of the piston module 570 may push the water from the inner longitudinal chamber 512 through the third port 538 of the integrated check valve module 530, and through the second port 536 of the integrated check valve module 530 into the annular base chamber 524. At this point, the first check valve 533 at the first port 534 of the integrated check valve module 530 may be closed, thus preventing the water from flowing back to the auxiliary base chamber 526. On the other hand, the second check valve 535 fitted at the opening 564 may be opened for air to be released from the filtration apparatus 500, 501 such that water may flow from the inner longitudinal chamber 512 into the auxiliary base chamber 526. As the pumping action of the piston module 570 continues, more air may be released from the filtration apparatus 500, 501 and the water may travel from the annular base chamber 524 through the inner lumen of the plurality of membrane fibres 518 of the filtration module 510 and then into the annular annex chamber 562. Once the annular annex chamber 562 is filled up, continuous pumping may cause the water to flow out through the second check valve 535 fitted at the opening 564 during the downward stroke of the piston module 570. At this point, the opening 522 of the base module 520 may be sealed or covered up, and the opening 516 of the filtration module 510 may be coupled to a water source. Subsequent pumping action may cause water to enter the sealed volume 517 via opening 516 of the filtration module. When sufficient pressure is generated, water may travel across the plurality of membrane fibres 518 into the lumen of the plurality of membrane fibres. Accordingly, particles, colloids, microorganisms and suspended solids which are lodged on the membrane surface during filtration, may be dislodged by the backwash water travelling across the plurality of the membrane fibres 518 into the lumen. The backwash water within the lumen of the membrane may then be flushed through the plurality of membranes fibres 518 into the annular annex chamber 562. The backwash water may then flow out of the annular annex chamber 562 through the second check valve 535 at the opening 564 of the annex module 560 to exit from the filtration apparatus 500, 501.

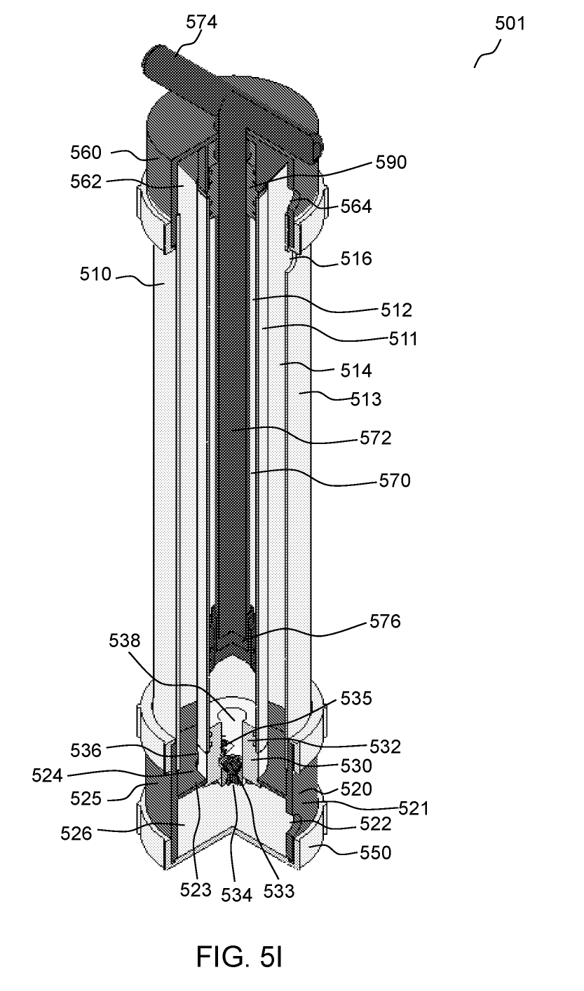

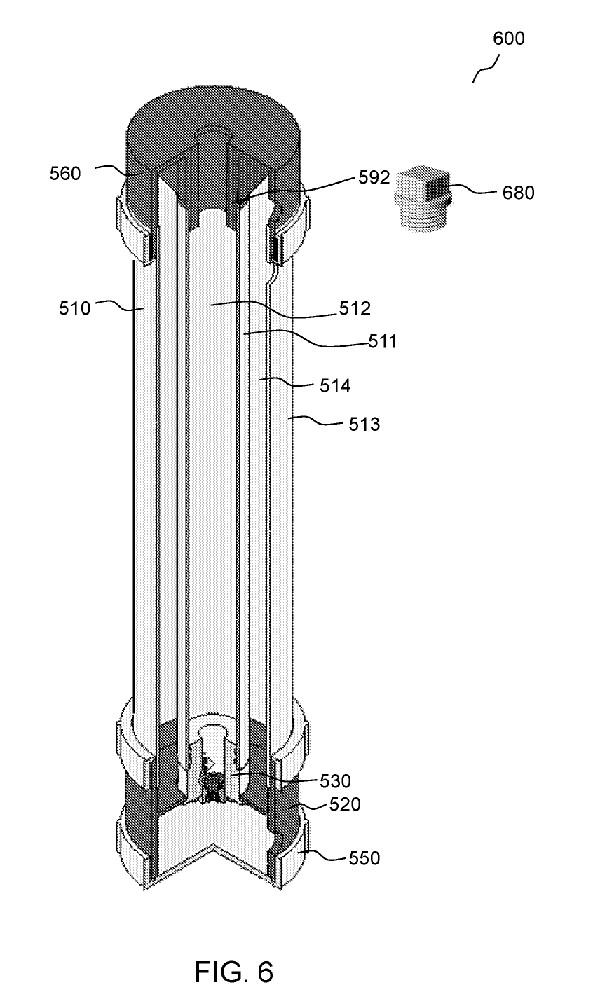

FIG. 6 shows a perspective view of a cut-out portion of a filtration apparatus 600 according to various embodiments. The filtration apparatus 600 may be similar to the filtration apparatus 500 of FIG. 5A except that the filtration apparatus 600 may further include a plug 680 coupled to another end of the inner longitudinal chamber 512 of the filtration module 510. According to various embodiments, connecting portion 592 may include a threaded inner wall for allowing the plug 680 to be connected to the connecting portion 592 to seal the inner longitudinal chamber 512. In this embodiment, the piston module 570 may be removed to facilitate alternative operation through the use of gravitational tank feed, electric pump, etc. According to various embodiments, the opening 522 of the base module 520 may be connected to the pump or the elevated water tank.

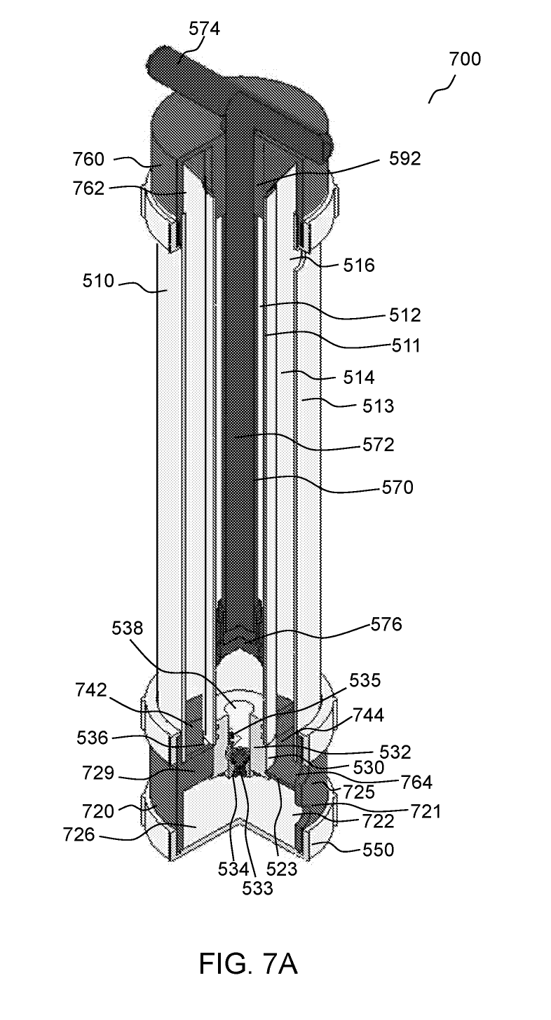

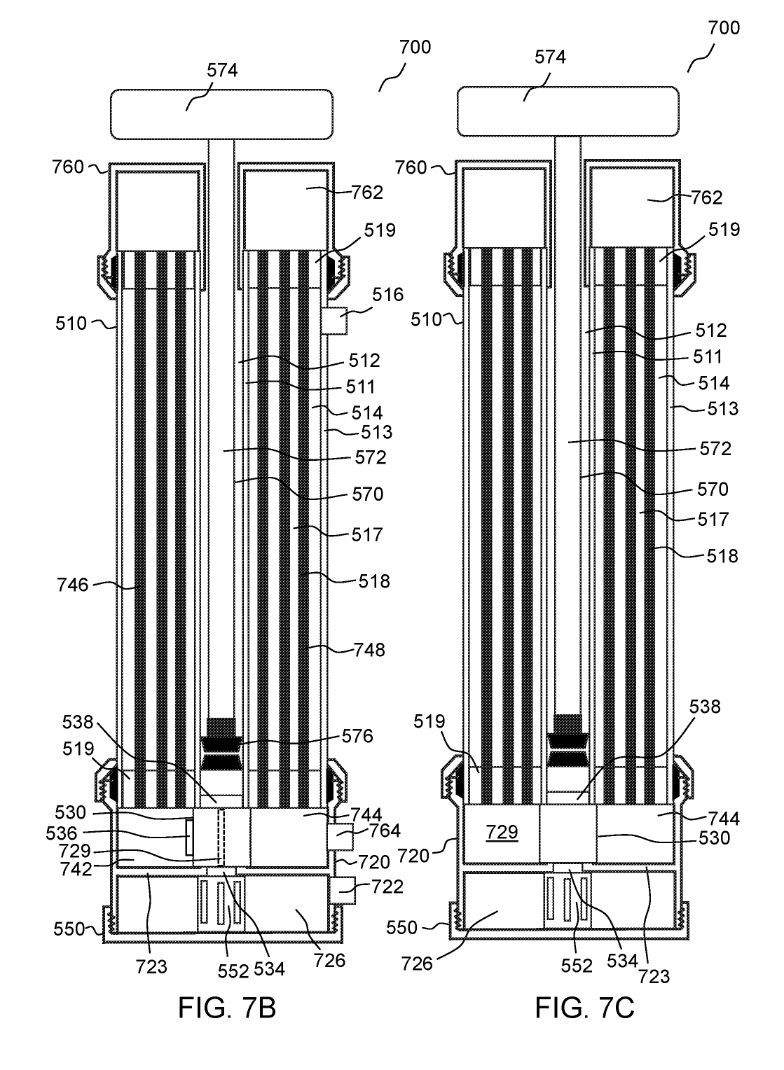

FIGS. 7A to 7C show a filtration apparatus 700 according to various embodiments. FIG. 7A shows a perspective view of a cut out portion of the filtration apparatus 700. FIG. 7B shows a side vertical cross-sectional view of the filtration apparatus 700. FIG. 7C shows a front vertical cross-sectional view of the filtration apparatus 700.

As shown in FIGS. 7A to 7C, the filtration apparatus 700 may differ from the filtration apparatus 500 of FIGS. 5A to 5E in that the base module 720 may include a partition wall 729 to divide the annular base chamber into two separate semi-annular base chambers 742, 744. Accordingly, the second port 536 of the integrated check valve module 530 may be configured to interface with a first semi-annular base chamber 742. Further, the base module 720 may include an opening 764 in an external wall 725 of the base module 720 to interface with a second semi-annular base chamber 744. Accordingly, the annex module 760 may not include the opening 564. According to various embodiments, the annex module 760 may further include an air valve (not shown).

In this embodiment, water may flow into the first semi-annular base chamber 742 from the second port 536 of the integrated check valve module 530. From the first semi-annular base chamber 742, the water may enter a first set 746 of the plurality of membrane fibres 518 from a bottom of the first set 746 of the plurality of membrane fibres 518. The first set 746 of the plurality of membrane fibres may be disposed directly above the first semi-annular base chamber 742. The water may flow through the lumen of the first set 746 of the plurality of membrane fibres and exit from a top of the first set of the plurality of membrane fibres 518 into the annular annex chamber 762. From the annular annex chamber 762, the water may enter a second set 748 of the plurality of membrane fibres 518 from a top of the second set 748 of the plurality of membrane fibres 518. The second set 748 of the plurality of membrane fibres 518 may be disposed directly above the second semi-annular base chamber 744. The water may flow down through the lumen of the second set 748 of the plurality of membrane fibres 518 and exit from a bottom of the second set of the plurality of membrane fibres 518 into the second semi-annular base chamber 744. Accordingly, the annular annex chamber 762 of the annex module 760 may serve to channel water from the first set 746 of the plurality of membrane fibres 518 to the second set 748 of the plurality of membrane fibres 518. Hence, the water may travel in a loop through the plurality of membrane fibres 518. Further, the air valve (not shown) may release air from the annular annex chamber 762 in the annex module 760 such that the annular annex chamber 762 may be fully filled with water.

In use, clean water may be produced by the filtration apparatus 700. To produce clean water with the filtration apparatus 700, the piston module 570 may be pulled upwards to create a suction pressure for dirty water to enter the filtration apparatus 700 through opening 722 in the base module 720. The dirty water may pass through the prefilter 552 in the auxiliary base chamber 726, leaving behind larger sized rocks and sediments that may damage the check valves and block the membrane. The water may then flow through the first check valve 533 at the first port 534 of the integrated check valve module 530, and through the third port 538 of the integrated check valve module 530 into the inner longitudinal chamber 512 of the filtration module 510. At this point, the second check valve 535 at the second port 536 of the integrated check valve module 530 may be closed. Subsequently, a downward push of the piston module 570 may push the water from the inner longitudinal chamber 512 through the third port 538 of the integrated check valve module 530, and through the second check valve 535 at the second port 536 of the integrated check valve module 530 into the first semi-annular base chamber 742. At this point, the first check valve 533 at the first port 534 of the integrated check valve module 530 may be closed, thus preventing the water from flowing back to the auxiliary base chamber 726. The partition wall 729 may prevent water from flowing into the second semi-annular base chamber 744. From the first semi-annular base chamber 742, water may travel up through the inner lumen of the first set 746 of the plurality of membrane fibres 518, which are directly above the first semi-annular base chamber 742. Water may then enter the annular annex chamber 762 and flow down through the inner lumen of the second set 748 of the plurality of membrane fibres 518, which are directly above the second semi-annular base chamber 744. With the opening 764 in an external wall 725 of the second semi-annular base chamber 744 of the base module 720 closed, continuous pumping of the piston module 570 may increase the pressure of the water within the lumen of the plurality of membrane fibres 518 such that water may be filtered across the plurality of membranes fibres 518. Accordingly clean water may be produced and collected in the sealed volume 517. Clean water may then exit from the filtration apparatus 700 through the opening 516 in the wall of the filtration module 510.

In use, the lumen of the plurality of membrane filters 518 may be cleaned. To clean the lumen of the plurality of membrane filters 518, the piston module 570 may be pulled upwards to create a suction pressure for water to enter the filtration apparatus 700 through opening 722 in the base module 720. The water may pass through the prefilter 552 in the auxiliary base chamber 726. The water may then flow through the first check valve 533 at the first port 534 of the integrated check valve module 530, and through the third port 538 of the integrated check valve module 530 into the inner longitudinal chamber 512 of the filtration module 510. At this point, the second check valve 535 at the second port 536 of the integrated check valve module 530 may be closed. Subsequently, a downward push of the piston module 570 may push the water from the inner longitudinal chamber 512 through the third port 538 of the integrated check valve module 530, and through the second check valve 535 at the second port 536 of the integrated check valve module 530 into the first semi-annular base chamber 742. At this point, the first check valve 533 at the first port 534 of the integrated check valve module 530 may be closed, thus preventing water from flowing back to the auxiliary base chamber 726. The partition wall 729 may prevent water from flowing into the second semi-annular base chamber 744. From the first semi-annular base chamber 742, the water may then travel up through the inner lumen of the first set 746 of the plurality of membrane fibres 518, which are directly above the first semi-annular base chamber 742, and may enter the annular annex chamber 762. From the annular annex chamber 762, the water may flow down through the inner lumen of the second set 748 of the plurality of membrane fibres 518, which are directly above the second semi-annular base chamber 744, into the second semi-annular base chamber 744. With the opening 764 in an external wall 725 of the second semi-annular base chamber 744 of the base module 720 opened, the water may exit from the filtration apparatus 700 through the opening 764. In this manner, particles, colloids, microorganisms and suspended solids within the lumen of the plurality of membrane fibres 518 may be flushed through the lumen of the plurality of membranes fibres 518 into the second semi-annular base chamber 744 and out from the opening 764 in the second semi-annular base chamber 744. Accordingly, the opening 764 in the wall 725 of the second semi-annular base chamber 744 may serve as a flush point for flushing out dirty water after the water is looped through the plurality of membrane fibres 518 to clean the lumen of the plurality of membrane fibres 518.

According to various embodiments, a portable water filtration system may be provided, the portable water filtration system may include (a) a filtration module, and (b) an integrated hand-operated piston pump located within said filtration module.

According to various embodiments, a method for purifying dirty water may be provided, wherein dirty water is drawn into a filtration module via the pressure generated by a hand-operated piston pump, and clean water is subsequently dispelled.

According to various embodiments, a method for cleaning a filtration module may be provided, wherein water may be used to flush out accumulated contaminants (including but not limited to microorganisms, colloids, suspended solids, and/or physical particles) from the lumen of the membrane fibres of said filtration module, via the pressure generated by a hand-operated piston pump.

According to various embodiments, the removable base cap (or bottom cap), the removable base module (or bottom section) and the removable annex module (or top section) may facilitate replacement of parts such as the filtration module, the integrated check valve module, the prefilters or the replaceable check valve.

According to various embodiments, the filtration module with the plurality of membrane fibres potted and sealed at both ends may minimise cross contamination as clean water output is isolated from dirty water.

According to various embodiments, the piston module or pump is integrated in the filtration module for uniform flow distribution.

According to various embodiments, flushing of the lumen of the plurality of membrane fibres may be easily achieved via turning on or off (i.e opening or closing) of the opening that serve as the flush point.

According to various embodiments, there is flexibility in operating the filtration apparatus whereby the piston module or the pump handle may be replaced with a connector to allow different input such as electric pumps, gravitational tank feed etc.

According to various embodiments, the base chamber in the base module (or the bottom section) that is in contact with the plurality of membrane fibres may be divided into two section to allow water to travel in a loop through the plurality of membrane fibres, allowing the opening (or flush point) in the annex module (or the top section) to be shifted to the base module. This may increase the effectiveness of flushing.

According to various embodiments, the integrated check valve may include a main body with T-shaped channel having two one-way check valves. The individual check valve may be detached from the main body of the integrated check valve to allow the reversal of the flow directions. This may allow water to travel on a reverse path and create a backwash process to recover the plurality of membrane fibres performance.

Various embodiments may overcome the limitations of the prior art by providing a portable water filtration system with integrated hand-operated piston pump which is highly deployable, and easy to operate, transport, and/or maintain. More specifically, the stream-lined configuration of the filtration apparatus according to various embodiments with its integrated hand-operated piston pump makes it easy to deploy, operate and/or transport in any location around the world (even in areas without electricity). The unique flushing mechanism that is used in various embodiments may also allow the filtration module to be easily and conveniently cleaned, without a need to substantially change the pump configuration to reverse the flow of water through the filtration module, or take apart the filtration module for cleaning, or attach additional bulky cleaning accessories. Various embodiments may include a filtration module, and a removable hand-operated piston pump which may be integrated into the filtration module for ease of operation and transport. Various embodiments may utilize an inside-out filtration process. Dirty water may enter into the lumen of the tubular/capillary membranes and filter outwards under a pressure driven force generated by the integrated hand-operated piston pump. Clean-filtered water may be produced and collected outside the membrane tubes, leaving the particles, colloids, microorganisms and suspended solids that are larger than the pore size of the membrane surface within the lumen of the membrane.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1. A filtration apparatus, comprising:
a filtration module having an inner longitudinal chamber and an outer annular chamber surrounding the inner longitudinal chamber;
a base module coupled to an end of the filtration module; and
an integrated check valve module coupled to a corresponding end of the inner longitudinal chamber of the filtration module through the base module,
wherein the base module and the integrated check valve module are configured to define an annular base chamber adjacent to a corresponding end of the outer annular chamber of the filtration module,
wherein the integrated check valve module comprises a housing having a first port for external fluid communication, a second port to interface with the annular base chamber and a third port to interface with the inner longitudinal chamber,
wherein the integrated check valve module comprises a first check valve removably coupled to the first port and a second check valve removably coupled to the second port,
wherein the outer annular chamber of the filtration module comprises a plurality of membrane fibres, and
wherein the plurality of membrane fibres is attached at both ends to the filtration module.

2. The filtration apparatus as claimed in claim 1, wherein the housing of the integrated check valve module comprises an integrally formed housing.

3-4. (canceled)

5. The filtration apparatus as claimed in claim 1, further comprising a base cap removably coupled to the base module, the base cap and the base module configured to form an auxiliary base chamber adjacent to the annular base chamber.

6. The filtration apparatus as claimed in claim 5, wherein the base module comprises an opening in an external wall of the base module, the opening is configured to interface with the auxiliary base chamber.

7. The filtration apparatus as claimed in claim 5, further comprising a prefilter contained in the auxiliary base chamber, the prefilter comprising any one of a mesh, a cloth, a paper, or a sponge.

8. The filtration apparatus as claimed in claim 5, further comprising a foot stand attached to the base cap.

9-10. (canceled)

11. The filtration apparatus as claimed in claim 1, wherein the filtration module comprises an opening in an external wall of the filtration module.

12. The filtration apparatus as claimed in claim 1, wherein the annular base chamber of the base module is concentric with the outer annular chamber of the filtration module.

13. The filtration apparatus as claimed in claim 1, further comprising an annex module coupled to another end of the filtration module.

14. The filtration apparatus as claimed in claim 13, wherein the annex module is configured to define an annular annex chamber adjacent to a corresponding end of the outer annular chamber of the filtration module.

15. The filtration apparatus as claimed in claim 14, wherein the annular annex chamber of the annex module is concentric with the outer annular chamber of the filtration module.

16. The filtration apparatus as claimed in claim 13, wherein the annex module comprises an opening in an external wall of the annex module.

17. The filtration apparatus as claimed in claim 13, wherein the base module comprises a partition wall to divide the annular base chamber into two separate semi-annular base chambers, and wherein the second port of the integrated check valve module is configured to interface with one of the two semi-annular base chambers, and wherein the base module comprises an opening in an external wall of the base module to interface with another one of the two separate semi-annular base chambers.

18. The filtration apparatus as claimed in claim 17, wherein the annex module comprises an air valve.

19. The filtration apparatus as claimed in claim 1, further comprising a piston module inserted into the inner longitudinal chamber of the filtration module.

20. The filtration apparatus as claimed in claim 19, wherein the piston module comprises a piston shaft, a handle at one end of the piston shaft and a piston head at another end of the piston shaft.

21. The filtration apparatus as claimed in claim 20, wherein the piston head comprises a double coned rubber piston head.

22. The filtration apparatus as claimed in claim 1, further comprising a plug coupled to another end of the inner longitudinal chamber of the filtration module.
